(19) United States
(12) Patent Application Publication
(10) Pub. No.: US 2023/0186895 A1
(43) Pub. Date: Jun. 15, 2023

(54) METHOD FOR PERFORMING SYNTHETIC SPEECH GENERATION OPERATION ON TEXT

(71) Applicant: NEOSAPIENCE, INC., Seoul (KR)

(72) Inventors: Taesu KIM, Suwon-si (KR); Younggun LEE, Seoul (KR); Suhee JO, Seoul (KR); Yookyung SHIN, Seoul (KR)

(73) Assignee: NEOSAPIENCE, INC., Seoul (KR)

(21) Appl. No.: 18/108,080

(22) Filed: Feb. 10, 2023

Related U.S. Application Data
(63) Continuation of application No. PCT/KR2020/017183, filed on Nov. 27, 2020.

(30) Foreign Application Priority Data
Aug. 14, 2020 (KR) 10-2020-0102500

(51) Int. Cl. G10L 13/10; G10L 13/027

(52) U.S. Cl. CPC G10L 13/10; G10L 13/027

(57) ABSTRACT

A method for performing the synthetic speech generation operation on text is provided, including receiving a plurality of sentences, receiving a plurality of speech style characteristics for the plurality of sentences, inputting the plurality of sentences and the plurality of speech style characteristics into an artificial neural network text-to-speech synthesis model, so as to generate a plurality of synthetic speeches for the plurality of sentences that reflect the plurality of speech style characteristics, and receiving a response to at least one of the plurality of synthetic speeches.

### CROSS-REFERENCE TO RELATED APPLICATIONS

The present application is a continuation of International Patent Application No. PCT/KR2020/017183, filed Nov. 27, 2020, which is based upon and claims the benefit of priority to Korean Patent Application No. 10-2020-0102500, filed on Aug. 14, 2020. The disclosures of the above-listed applications are hereby incorporated by reference herein in their entirety.

### TECHNICAL FIELD

The present disclosure relates to a method for performing a synthetic speech generation operation on text, and more particularly, to a method and system in which the synthetic speech generation operation is jointly performed by an operator selecting a plurality of speech style characteristics for a plurality of sentences and an inspector inspecting a generated synthetic speech.

### BACKGROUND

With the development of synthetic speech generation technology for text and audio content production technology and the increasing demand for speech content, the audiobook market has been rapidly growing. Creating audiobooks from conventional books comprised of text may require a process of generating synthetic speeches by operators directly inputting speaker characteristics, utterance style characteristics, emotion characteristics, prosody characteristics, or the like suitable for each sentence. In addition, the quality or completeness of the audiobooks can be improved through a process of inspecting, modifying, and supplementing the generated synthetic speeches.

However, in the related system, it is cumbersome, since a synthetic speech generated through the synthetic speech generation operation by an operator has to be delivered directly to an inspector, and the inspector has to listen to the generated synthetic speech and deliver a part that requires modification and supplementation directly to the operator. In addition, in the related system, it takes a lot of time since the inspector has to listen to all the synthetic speeches and find a part that requires modification and supplementation. Due to the cumbersomeness of such related system, there is increasing interest and demand for a technology in which the operator and the inspector jointly perform the synthetic speech generation operation quickly and easily.

### SUMMARY

Embodiments of the present disclosure relate to a method for jointly performing a synthetic speech generation operation on text, by receiving a plurality of speech style characteristics for a plurality of sentences from an operator and generating and providing a plurality of synthetic speeches to an inspector, and receiving a response to the plurality of synthetic speeches from the inspector and providing it to the operator.

The present disclosure may be implemented in a variety of ways, including a method, a system, apparatus, or a non-transitory computer-readable recording medium storing instructions.

A method for performing the synthetic speech generation operation on text may include receiving a plurality of sentences, receiving a plurality of speech style characteristics for the plurality of sentences, inputting the plurality of sentences and the plurality of speech style characteristics into an artificial neural network text-to-speech synthesis model, so as to generate a plurality of synthetic speeches for the plurality of sentences that reflect the plurality of speech style characteristics; and receiving a response to at least one of the plurality of synthetic speeches.

The receiving the response to the at least one of the plurality of synthetic speeches may include selecting at least one sentence to be an inspection target from among the plurality of sentences based on a result of analyzing at least one of the plurality of speech style characteristics or the plurality of synthetic speeches, outputting a visual representation indicating the inspection target in an area corresponding to the selected at least one sentence, and receiving a request to change at least one speech style characteristic corresponding to the at least one sentence.

The receiving the response to the at least one of the plurality of synthetic speeches may further include receiving a request to change at least one sentence associated with the at least one synthetic speech, and the method may further include inputting the changed at least one speech style characteristic and the changed at least one sentence into the artificial neural network text-to-speech synthesis model, so as to generate at least one synthetic speech for the changed at least one sentence that reflects the changed at least one speech style characteristic.

The receiving the plurality of speech style characteristics for the plurality of sentences may include receiving, from a first user account, a plurality of speech style characteristics for the plurality of sentences, and the receiving the response to the at least one of the plurality of synthetic speeches may include receiving, from a second user account, a response to the at least one synthetic speech. The first user account may be different from the second user account.

The receiving, from the second user account, the response to the at least one synthetic speech may include selecting at least one sentence to be an inspection target from among the plurality of sentences by analyzing a behavior pattern of the first user account that selects the plurality of speech style characteristics for the plurality of sentences, outputting a visual representation indicating the inspection target in an area corresponding to the selected at least one sentence, and receiving, from the second user account, a request to change at least one speech style characteristic corresponding to the at least one sentence.

The receiving, from the second user account, the response to the at least one synthetic speech may further include receiving a marker indicating whether or not to use at least one synthetic speech in an area displaying at least one sentence associated with the at least one synthetic speech.

The method may further include, if the marker indicates that the at least one synthetic speech is not to be used, providing information on at least one sentence associated with the at least one synthetic speech to the first user account.

The receiving the plurality of speech style characteristics for the plurality of sentences may include outputting a plurality of speech style characteristic candidates for each of the plurality of sentences, and receiving a response for selecting at least one speech style characteristic from among the plurality of speech style characteristic candidates.

The plurality of speech style characteristic candidates may include a recommended speech style characteristic candidate that is determined based on a result of analyzing the plurality of sentences.

There is provided a non-transitory computer-readable recording medium storing instructions for executing the method for performing the synthetic speech generation operation on text on a computer.

According to some embodiments of the present disclosure, by inspecting, modifying, and supplementing at least one of synthetic speeches for a plurality of sentences, it is possible to produce synthetic speeches and audio content with fewer defects and natural to listen to.

According to some embodiments of the present disclosure, a plurality of users (e.g., operator and inspector) may jointly perform the synthetic speech generation operation, thereby generating synthetic speeches more efficiently.

According to some embodiments of the present disclosure, a recommended speech style characteristic candidate for at least one of a plurality of sentences may be provided to an operator, thereby allowing the operator to easily select a more natural speech style characteristic and effectively perform the synthetic speech generation operation.

According to some embodiments of the present disclosure, a visual representation may be output for sentences expected to require inspection without the inspector having to listen to all of the synthetic speeches, thereby allowing the inspector to perform inspection focusing on the sentences expected to require inspection, and accordingly, allowing the inspection operation on the generated synthetic speeches to be quickly performed.

According to some embodiments of the present disclosure, based on the inspector’s response to at least one of a plurality of synthetic speeches, a marker may be output to an area associated with at least one speech and/or the corresponding sentence requiring the operator’s inspection, thereby allowing the operator to quickly recognize sentences requiring modification and supplementation.

### BRIEF DESCRIPTION OF THE DRAWINGS

The above and other objects, features and advantages of the present disclosure will be described with reference to the accompanying drawings described below, where similar reference numerals indicate similar elements, but not limited thereto, in which:

FIG. 1 is a diagram illustrating an example of a user interface for performing a synthetic speech generation operation on text;

FIG. 2 is a schematic diagram illustrating a configuration in which a plurality of user terminals and an information processing system are communicatively connected to each other to perform the synthetic speech generation operation on text;

FIG. 3 is a block diagram of an internal configuration of the user terminal and the information processing system;

FIG. 4 is a block diagram of an internal configuration of a processor of the user terminal;

FIG. 5 is a block diagram illustrating an internal configuration of a processor of the information processing system;

FIG. 6 is a diagram illustrating a configuration of an artificial neural network-based text-to-speech synthesis device, and a network for extracting an embedding vector that can distinguish each of a plurality of speakers and/or speech style characteristics;

FIG. 7 is a flowchart illustrating a method for performing the synthetic speech generation operation;

FIG. 8 is a diagram illustrating an operation in a user interface of an operator generating a synthetic speech;,

FIG. 9 is a diagram illustrating an operation in a user interface of an operator generating a synthetic speech;

FIG. 10 is a diagram illustrating an operation in a user interface of an inspector inspecting a generated synthetic speech; and

FIG. 11 is a diagram illustrating an operation in a user interface of an operator generating a synthetic speech.

### DETAILED DESCRIPTION

Hereinafter, example details for the practice of the present disclosure will be described in detail with reference to the accompanying drawings. However, in the following description, detailed descriptions of well-known functions or configurations will be omitted if it may make the subject matter of the present disclosure rather unclear.

In the accompanying drawings, the same or corresponding components are assigned the same reference numerals. In addition, in the following description of various examples, duplicate descriptions of the same or corresponding components may be omitted. However, even if descriptions of components are omitted, it is not intended that such components are not included in any example.

Advantages and features of the disclosed examples and methods of accomplishing the same will be apparent by referring to examples described below in connection with the accompanying drawings. However, the present disclosure is not limited to the examples disclosed below, and may be implemented in various forms different from each other, and the examples are merely provided to make the present disclosure complete, and to fully disclose the scope of the disclosure to those skilled in the art to which the present disclosure pertains.

The terms used herein will be briefly described prior to describing the disclosed example(s) in detail. The terms used herein have been selected as general terms which are widely used at present in consideration of the functions of the present disclosure, and this may be altered according to the intent of an operator skilled in the art, related practice, or introduction of new technology. In addition, in specific cases, certain terms may be arbitrarily selected by the applicant, and the meaning of the terms will be described in detail in a corresponding description of the example(s). Therefore, the terms used in the present disclosure should be defined based on the meaning of the terms and the overall content of the present disclosure rather than a simple name of each of the terms.

As used herein, the singular forms “a,” “an,” and “the” are intended to include the plural forms as well, unless the context clearly indicates the singular forms. Further, the plural forms are intended to include the singular forms as well, unless the context clearly indicates the plural forms. Further, throughout the description, if a portion is stated as “comprising (including)” a component, it intends to mean that the portion may additionally comprise (or include or have) another component, rather than excluding the same, unless specified to the contrary.

Furthermore, the term “unit” or “module” used herein denotes a software or hardware element, and the “module” performs certain roles. However, the meaning of the “unit” or “module” is not limited to software or hardware. The “unit” or “module” may be configured to be in an addressable storage medium or to execute one or more processors. Accordingly, as an example, the “unit” or “module” may include components such as software components, object-oriented software components, class components, and task components, and at least one of processes, functions, attributes, procedures, subroutines, program code segments of program code, drivers, firmware, micro-codes, circuits, data, database, data structures, tables, arrays, and variables. Furthermore, functions provided in the elements and the “units” or “modules” may be combined as a smaller number of elements and “units” or “modules,” or further divided into additional elements and “units” or “modules.”

According to an embodiment of the present disclosure, the “unit” or “module” may be implemented as a processor and a memory. The “processor” should be interpreted broadly to encompass a general-purpose processor, a central processing unit (CPU), a microprocessor, a digital signal processor (DSP), a controller, a microcontroller, a state machine, and so forth. Under some circumstances, the “processor” may refer to an application-specific integrated circuit (ASIC), a programmable logic device (PLD), a field-programmable gate array (FPGA), and so on. The “processor” may refer to a combination for processing devices, e.g., a combination of a DSP and a microprocessor, a combination of a plurality of microprocessors, a combination of one or more microprocessors in conjunction with a DSP core, or any other combination of such configurations. In addition, the “memory” should be interpreted broadly to encompass any electronic component that is capable of storing electronic information. The “memory” may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, and so on. The memory is said to be in electronic communication with a processor if the processor can read information from and/or write information to the memory. The memory integrated with the processor is in electronic communication with the processor.

As used herein, the “speech style characteristic” may include a component and/or identification element of a speech. For example, the speech style characteristic may include an utterance style characteristics (e.g., tone, strain, parlance, and the like), a speech speed, an accent, an intonation, a pitch, a loudness, a frequency, a break reading, an inter-sentence pause, and the like. In addition, as used herein, a “character” may include a speaker or character uttering the text. In addition, the “character” may include a predetermined speech style characteristic corresponding to each character. The “character” and the “speech style characteristic” may be used separately, but the “character” may be included in the “speech style characteristic.”

As used herein, a “sentence” may refer to a plurality of texts divided based on a punctuation mark such as a period, an exclamation mark, a question mark, a quotation mark, and the like. For example, the text “Today is the day we meet customers and listen to and answer questions.” can be divided into a separate sentence from the subsequent texts based on the period. In addition, the “sentence” may be divided from the text in response to a user’s input for sentence division. That is, one sentence formed by dividing the text based on the punctuation mark may be divided into at least two sentences in response to a user’s input for sentence division. For example, in a sentence “After eating, we went home,” by inputting an Enter after “eating,” user can divide the sentence into a sentence “After eating” and a sentence “we went home.”

In the present disclosure, the “user account” may represent an account used in the synthetic speech generation operation system or data related thereto. In addition, the user account may refer to a user using a user interface for performing the synthetic speech generation operation and/or a user terminal in which the user interface for performing the synthetic speech generation operation is operated. Further, the user account may include one or more user accounts. In addition, a first user account (or operator) and a second user account (or inspector) are used separately as different user accounts, but the first user account (or operator) and the second user account (or inspector) may be the same as each other.

Hereinafter, examples will be fully described with reference to the accompanying drawings in such a way that those skilled in the art can easily carry out the examples. Further, in order to clearly illustrate the present disclosure, parts not related to the description are omitted in the drawings.

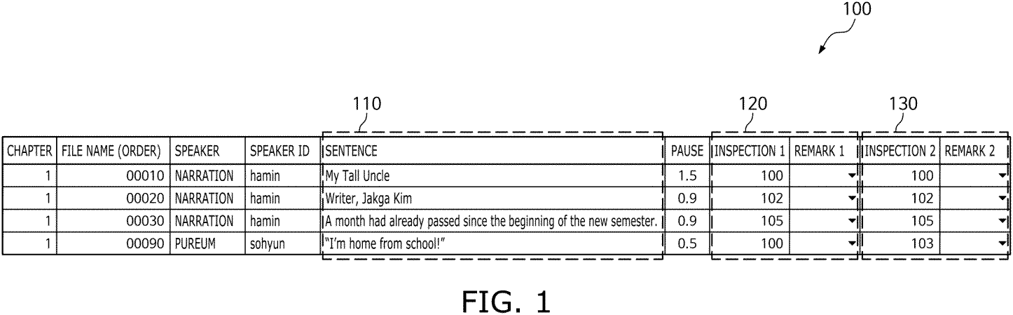

FIG. 1 is a diagram illustrating an example of a user interface 100 for performing the synthetic speech generation operation on text. The user interface for performing the synthetic speech generation operation on text may be provided to a user terminal that is operable by a user. The user terminal (not shown) may refer to any electronic device with one or more processors and memory, and the user interface may be displayed on an output device (e.g., a display) connected to or included in the user terminal. In addition, the synthetic speech generation operation on text may be performed by one or more users and/or user terminals. In addition, in order to perform the synthetic speech generation operation on text, the user terminal may be configured to communicate with an information processing system (not shown) configured to generate a synthetic speech for text.

One or more user accounts may participate in or perform the synthetic speech generation operation on text. The synthetic speech generation operation on text may be provided as one project (e.g., audio book creation, and the like), and one or more user accounts may be allowed to access the project. A plurality of user accounts may jointly participate in synthetic speech generation and/or inspection operations on text. For example, each of the one or more user accounts may perform at least a portion of the synthetic speech generation operation on text. The synthetic speech generation operation on text may refer to any operation required to generate a synthetic speech for text, and may include, for example, an operation of providing a plurality of sentences, an operation of providing a plurality of speech style characteristics for the plurality of sentences, an operation of generating the synthetic speech by inputting the plurality of sentences and the plurality of speech style characteristics into an artificial neural network text-to-speech synthesis model, and an operation of providing a response (e.g., inspection, modification, or the like) to a generated synthetic speech, and the like, but is not limited thereto.

The information processing system may receive a plurality of sentences from at least one of a plurality of user accounts. The at least one of the plurality of user accounts may upload a document format file including a plurality of sentences 110, so that the plurality of sentences 110 may be received and displayed through a user interface. The user interface may refer to a user interface for the synthetic speech generation operation on text, which is operated in a user terminal of the at least one user account. For example, a document format file accessible from the at least one of the plurality of user accounts or accessible through a cloud system may be uploaded. The document format file may refer to any document format file that can be supported by the user terminal and/or the information processing system, such as a project file, a text file, or the like which are editable or allow extraction of text, for example. The plurality of sentences 110 may be received through the user interface from the at least one user account. For example, the plurality of sentences 110 may be input or received through an input device (e.g., a keyboard, a touch screen, or the like) included in or connected to the user terminal used by the at least one user account.

The plurality of sentences 110 received as described above may be displayed on screens of the user terminals used by a plurality of user accounts participating in a project associated with the plurality of sentences 110. The user interfaces displayed on the screens of respective terminals of the plurality of user accounts may be the same as each other. For example, the user interface shown in FIG. 1 may be equally provided to the plurality of user accounts participating in the project. Alternatively, the user interfaces provided to the plurality of user accounts participating in the project may not all be the same. For example, the user interfaces provided to the plurality of user accounts may be different from each other according to a role of which each of the plurality of user accounts is required to do in the synthetic speech generation operation.

The information processing system may receive a plurality of speech style characteristics for a plurality of sentences from at least one of the plurality of user accounts. The plurality of speech style characteristics for the plurality of sentences may be received from the at least one user account through the user interface. For example, an input for the plurality of speech style characteristics for the plurality of sentences may be received through an input device (e.g., a keyboard, a touch screen, a mouse, or the like) available to the at least one user account. In this case, the plurality of speech style characteristics may be input as markers (numerical values, symbols, or the like) to areas corresponding to the plurality of sentences. These markers may be pre-stored in association with predetermined speech style characteristics.

The plurality of sentences and the plurality of speech style characteristics for the plurality of sentences received as described above may be input into an artificial neural network text-to-speech synthesis model, so as to generate a plurality of synthetic speeches for the plurality of sentences that reflect the plurality of speech style characteristics. The plurality of synthetic speeches for the plurality of sentences generated as described above may be output through an output device included in or connected to one user terminal. The user of the user terminal may determine whether or not the output speeches appropriately correspond to the corresponding text and/or the context of the text. Alternatively, another user account in the project may determine whether or not the speeches generated as described above is appropriate.

The information processing system may receive a response to at least one of a plurality of synthetic speeches for a plurality of sentences from at least one of a plurality of user accounts (for example, one or more operators, inspectors, or the like in the project). In response to the outputted at least one synthetic speech, the information processing system may receive an input to re-input or change at least a portion of the plurality of speech style characteristics from the at least one of the plurality of user accounts. In response to the outputted at least one synthetic speech, the information processing system may receive, from the at least one of the plurality of user accounts, whether or not to use the at least one synthetic speech of the plurality of synthetic speeches. For example, a marker corresponding to the received response may be displayed in an area corresponding to a sentence associated with the at least one synthetic speech.

Information representing or characterizing each of the plurality of sentences included in a sentence area 110 may be determined or input. As shown in FIG. 1, the user interface may include a file name order, a speaker, a speaker ID, a pause, and one or more inspection areas 120 and 130 for each sentence of the plurality of sentences included in the sentence area 110 in the same row as the sentence. The file name order may refer to the order in which a plurality of sentences received in the project are arranged. In addition, the speaker may refer to a speaker of a synthetic speech corresponding to each of the plurality of sentences, and the speaker ID may refer to an ID corresponding to the speaker. The speaker and/or speaker ID may be associated with the character. In addition, the pause may refer to an interval between the corresponding sentence and the next sentence.

Each of the inspection areas 120 and 130 may include an inspection part and a remark part. An utterance style characteristic may be input in an inspection part 1 and/or an inspection part 2 by the operator or the inspector. In each of a remark part 1 and a remark part 2, notes and/or comments on the corresponding sentence may be input by the operator or the inspector that makes inputs to each of the inspection part 1 and the inspection part 2. The inspection area 120 including the inspection part 1 and the remark part 1 may be input or modified by the operator that performs the project, and the inspection area 130 including the inspection part 2 and the remark part 2 may be input or modified by the inspector that inspects a synthetic speech done by the operator in the project.

The plurality of user accounts may perform a plurality of operations through the user interface 100 to generate a synthetic speech for text. As shown in FIG. 1, in a first operation for generating a synthetic speech, a user account corresponding to an operator, that is, an operator account may input “hamin” for the character of the first sentence, “1.5” for the pause, and “100” for the utterance style characteristic, and may input “hamin” for the character of the second sentence, “0.9” for the pause, and “102” for the utterance style characteristic. In a similar manner, “hamin” may be input for the character of the third sentence, “0.9” for the pause, and “105” for the utterance style characteristic, and “sohyun” may be input for the character of the fourth sentence, “0.5” for the pause, and “100” for the utterance style characteristic. Alternatively, a plurality of operator accounts may jointly work on the character, pause, and utterance style characteristic for each of the plurality of sentences. For example, the plurality of sentences may be divided and assigned to a plurality of user accounts, that is, to a plurality of operator accounts, so that the plurality of user accounts can perform the synthetic speech generation operation on the assigned sentences.

A synthetic speech may be generated, which reflects speech style characteristics for the plurality of sentences input in the first operation. The synthetic speech generated as described above may be output through an output device of the user terminal of the operator account that has performed the synthetic speech generation operation. In addition, this synthetic speech may be provided and output to another user account (e.g., inspector account) participating in the project.

Based on the synthetic speech generated by the first operation, at least one user account (e.g., inspector account) of the plurality of user accounts may perform a second operation. In the second operation, the inspector account may confirm the speech style characteristics for the first sentence, second sentence, and third sentence, and input or change, in the corresponding region in the inspection area 130, the utterance style characteristic for the fourth sentence to “103” which is different from the utterance style characteristic set in the first operation. While FIG. 1 illustrates the performance of only two operations, that is, the first operation and the second operation, aspects are not limited thereto, and three or more operations (e.g., operations performed by a plurality of operators and/or a plurality of inspectors) may be performed. In addition, while FIG. 1 illustrates that the second operation involves inputting or changing the utterance style characteristic of the speech style characteristics, aspects are not limited thereto, and an operation of inputting or modifying a plurality of sentences and/or speech style characteristics, such as character modification, sentence editing, pause editing, or the like may be performed.

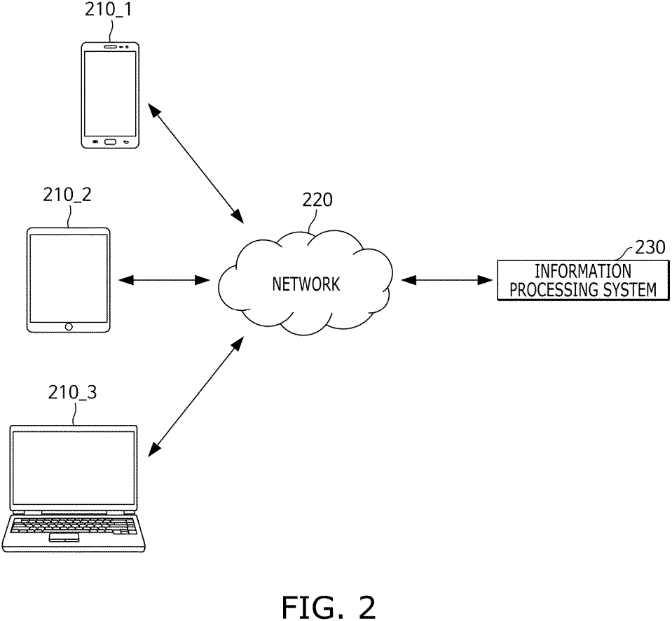

FIG. 2 is a schematic diagram illustrating a configuration in which a plurality of user terminals 210_1, 210_2, and 210_3 and an information processing system 230 are communicatively connected to each other to perform the synthetic speech generation operation on text.

The plurality of user terminals 210_1, 210_2, and 210_3 may communicate with the information processing system 230 through a network 220. The network 220 may be configured to enable communication between the plurality of user terminals 210_1, 210_2, and 210_3 and the information processing system 230. The network 220 may be configured as a wired network 220 such as Ethernet, a wired home network (Power Line Communication), a telephone line communication device and RS-serial communication, a wireless network 220 such as a mobile communication network, a wireless LAN (WLAN), Wi-Fi, Bluetooth, and ZigBee, or a combination thereof, depending on the installation environment. The method of communication is not limited, and may include a communication method using a communication network (e.g., mobile communication network, wired Internet, wireless Internet, broadcasting network, satellite network, and the like) that may be included in the network 220 as well as short-range wireless communication between the user terminals 210_1, 210_2, and 210_3. For example, the network 220 may include any one or more of networks including a personal area network (PAN), a local area network (LAN), a campus area network (CAN), a metropolitan area network (MAN), a wide area network (WAN), a broadband network (BBN), the Internet, and the like. In addition, the network 220 may include any one or more of network topologies including a bus network, a star network, a ring network, a mesh network, a star-bus network, a tree or hierarchical network, and the like, but not limited thereto.

In FIG. 2, a mobile phone or smart phone 210_1, a tablet computer 210_2, and a laptop or desktop computer 210_3 are illustrated as examples of user terminals that execute or operate a user interface for performing the synthetic speech generation operation on text, but aspects are not limited thereto, and the user terminals 210_1, 210_2, and 210_3 may be any computing device that is capable of wired and/or wireless communication and that allows a web browser or an application, that is capable of the synthetic speech generation operation, to be installed and a user interface for performing the synthetic speech generation operation on text to be executed. For example, a user terminal 210 may include a smart phone, a mobile phone, a navigation terminal, a desktop computer, a laptop computer, a digital broadcasting terminal, a personal digital assistant (PDA), a portable multimedia player (PMP), a tablet computer, a game console, a wearable device, an internet of things (IoT) device, a virtual reality (VR) device, an augmented reality (AR) device, and the like. In addition, while FIG. 2 illustrates that three user terminals 210_1, 210_2, and 210_3 are in communication with the information processing system 230 through the network 220, aspects are not limited thereto, and a different number of user terminals may be configured to be in communication with the information processing system 230 through the network 220.

The user terminals 210_1, 210_2, and 210_3 may receive a plurality of sentences through a user interface for performing the synthetic speech generation operation on text. According to a text input through an input device (e.g., a keyboard) connected to or included in the user terminals 210_1, 210_2, and 210_3, the user terminals 210_1, 210_2, and 210_3 may receive a plurality of sentences. A plurality of sentences included in a document format file uploaded through the user interface may be received.

The user terminals 210_1, 210_2, and 210_3 may receive a plurality of speech style characteristics for a plurality of sentences through a user interface for performing the synthetic speech generation operation on text. An input for at least one speech style characteristic of a plurality of speech style characteristic candidates may be received. The speech style characteristic candidates may include a recommended speech style characteristic candidate that is determined based on a result of analyzing the plurality of sentences. For example, as a result of analyzing one sentence through natural language processing, a context such as a character and/or emotion of the sentence may be recognized, and the recommended speech style characteristic candidate may be determined based on the context. According to a speech style characteristic input through an input device (e.g., a keyboard) connected to or included in the user terminals 210_1, 210_2, and 210_3, the user terminals 210_1, 210_2, and 210_3 may receive a speech style characteristic.

The plurality of sentences and/or the plurality of speech style characteristics for the plurality of sentences received by the user terminals 210_1, 210_2, and 210_3 may be provided to the information processing system 230 or another user terminal. That is, the information processing system 230 may receive a plurality of sentences and/or a plurality of speech style characteristics through the network 220 from the user terminals 210_1, 210_2, and 210_3, and another user terminal may receive a plurality of sentences and/or a plurality of speech style characteristics through the network 220 from the information processing system 230 or the user terminals 210_1, 210_2, and 210_3.

The user terminals 210_1, 210_2, and 210_3 may receive a plurality of synthetic speeches for a plurality of sentences through the network 220 from the information processing system 230. The user terminals 210_1, 210_2, and 210_3 may receive a plurality of synthetic speeches for a plurality of sentences that reflect a plurality of speech style characteristics from the information processing system 230. The plurality of synthetic speeches may be generated by inputting the received plurality of sentences and the received plurality of speech style characteristics into an artificial neural network text-to-speech synthesis model in the information processing system 230. The synthetic speeches received from the information processing system 230 may be output through an output device (e.g., a speaker) of the user terminals 210_1, 210_2, and 210_3.

The user terminals 210_1, 210_2, and 210_3 may receive a response to at least one of a plurality of synthetic speeches through a user interface for performing the synthetic speech generation operation on text. The user terminal may receive a request to change at least one speech style characteristic corresponding to at least one sentence. The user terminal may receive a request to change or modify at least one sentence associated with at least one synthetic speech. The user terminal may receive a marker indicating whether or not to use the at least one synthetic speech in an area displaying at least one sentence associated with the at least one synthetic speech.

The user terminals 210_1, 210_2, and 210_3 may provide a response to at least one of a plurality of synthetic speeches to the information processing system 230 or another user terminal. That is, the information processing system 230 may receive a response to at least one of a plurality of synthetic speeches through the network 220 from the user terminals 210_1, 210_2, and 210_3, and another user terminal may receive a response to at least one of a plurality of synthetic speeches through the network 220 from the information processing system 230 or the user terminals 210_1, 210_2, and 210_3.

FIG. 2 shows each of the user terminals 210_1, 210_2, 210_3 and the information processing system 230 as separate elements, but aspects are not limited thereto, and the information processing system 230 may be configured to be included in each of the user terminals 210_1, 210_2, and 210_3.

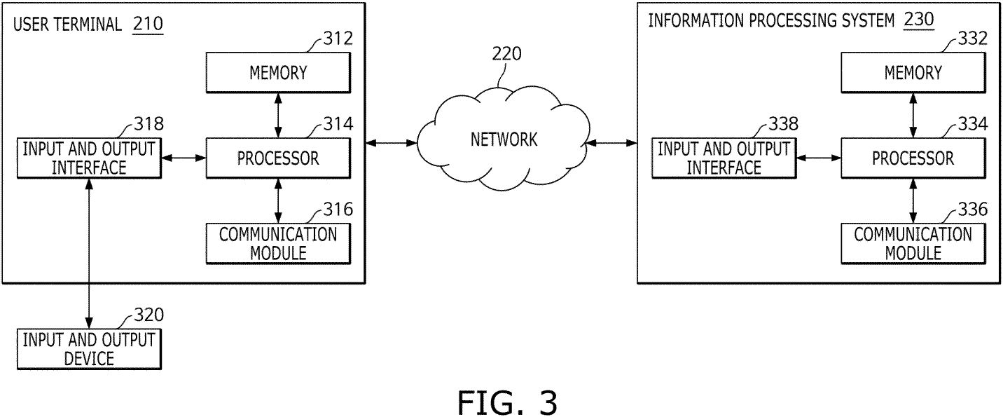

FIG. 3 is a block diagram of an internal configuration of the user terminal 210 and the information processing system 230. The user terminal 210 may refer to any computing device capable of wired and/or wireless communication, and may include the mobile phone or the smart phone 210_1, the tablet computer 210_2, the PC computer 210_3 of FIG. 2, and the like, for example. As illustrated, the user terminal 210 may include a memory 312, a processor 314, a communication module 316, and an input and output interface 318. Likewise, the information processing system 230 may include a memory 332, a processor 334, a communication module 336, and an input and output interface 338. As illustrated in FIG. 3, the user terminal 210 and the information processing system 230 may be configured to communicate information and/or data through the network 220 using respective communication modules 316 and 336. In addition, an input and output device 320 may be configured to input information and/or data to the user terminal 210 or output information and/or data generated from the user terminal 210 through the input and output interface 318.

The memories 312 and 332 may include any non-transitory computer-readable recording medium. The memories 312 and 332 may include a permanent mass storage device such as random access memory (RAM), read only memory (ROM), disk drive, solid state drive (SSD), flash memory, and so on. As another example, a non-destructive mass storage device such as ROM, SSD, flash memory, disk drive, and so on may be included in the user terminal 210 or the information processing system 230 as a separate permanent storage device that is distinct from the memory. In addition, an operating system and at least one program code (e.g., a code for providing a synthetic speech generation collaboration service through a user interface, a code for an artificial neural network text-to-speech synthesis model, and the like) may be stored in the memories 312 and 332.

These software components may be loaded from a computer-readable recording medium separate from the memories 312 and 332. Such a separate computer-readable recording medium may include a recording medium directly connectable to the user terminal 210 and the information processing system 230, and may include a computer-readable recording medium such as a floppy drive, a disk, a tape, a DVD/CD-ROM drive, a memory card, and the like, for example. As another example, the software components may be loaded into the memories 312 and 332 through the communication modules rather than the computer-readable recording medium. For example, at least one program may be loaded into the memories 312 and 332 based on a computer program (for example, artificial neural network text-to-speech synthesis model program, and the like) installed by files provided by developers or a file distribution system for distributing an installation file of an application or an application through the network 220.

The processors 314 and 334 may be configured to process the instructions of the computer program by performing basic arithmetic, logic, and input and output operations. The instructions may be provided to the processors 314 and 334 from the memories 312 and 332 or the communication modules 316 and 336. For example, the processors 314 and 334 may be configured to execute the received instructions according to a program code stored in a recording device such as the memories 312 and 332.

The communication modules 316 and 336 may provide a configuration or function for the user terminal 210 and the information processing system 230 to communicate with each other through the network 220, and may provide a configuration or function for the user terminal 210 and/or the information processing system 230 to communicate with another user terminal or another system (e.g., a separate cloud system, separate synthetic speech content sharing support system or the like). For example, a request (for example, a request to generate a synthetic speech) generated by the processor 314 of the user terminal 210 according to the program code stored in the recording device such as the memory 312 and the like may be transmitted to the information processing system 230 through the network 220 under the control of the communication module 316. Conversely, a control signal or a command provided under the control of the processor 334 of the information processing system 230 may be received by the user terminal 210 through the communication module 316 of the user terminal 210 through the communication module 336 and the network 220.

The input and output interface 318 may be a means for interfacing with the input and output device 320. As an example, the input device may include a device such as a keyboard, a microphone, a mouse, and a camera including an image sensor, and the output device may include a device such as a display, a speaker, a haptic feedback device, and the like. As another example, the input and output interface 318 may be a means for interfacing with a device such as a touch screen or the like that integrates a configuration or function for performing inputting and outputting. For example, if the processor 314 of the user terminal 210 processes the instructions of the computer program loaded in the memory 312, a service screen or content, which is configured with the information and/or data provided by the information processing system 230 or other user terminals 210, may be displayed on the display through the input and output interface 318.

While FIG. 3 illustrates that the input and output device 320 is not included in the user terminal 210, aspects are not limited thereto, and the input and output device 320 may be configured as one device with the user terminal 210. In addition, the input and output interface 338 of the information processing system 230 may be a means for interface with a device (not illustrated) for inputting or outputting that may be connected to, or included in the information processing system 230. While FIG. 3 illustrates the input and output interfaces 318 and 338 as the components configured separately from the processors 314 and 334, aspects are not limited thereto, and the input and output interfaces 318 and 338 may be configured to be included in the processors 314 and 334.

The user terminal 210 and the information processing system 230 may include more than those components illustrated in FIG. 3. Meanwhile, it would be unnecessary to exactly illustrate most of the related components. The user terminal 210 may be implemented to include at least a part of the input and output device 320 described above. In addition, the user terminal 210 may further include other components such as a transceiver, a Global Positioning System (GPS) module, a camera, various sensors, a database, and the like. For example, if the user terminal 210 is a smartphone, it may include components generally included in the smartphone. For example, in an implementation, various components such as an acceleration sensor, a gyro sensor, a camera module, various physical buttons, buttons using a touch panel, input and output ports, a vibrator for vibration, and so on may be further included in the user terminal 210.

The processor 314 may receive texts, images, and the like, which may be inputted or selected through the input device 320 such as a touch screen, a keyboard, or the like connected to the input and output interface 318, and store the received texts, and/or images in the memory 312 or provide them to the information processing system 230 through the communication module 316 and the network 220. For example, the processor 314 may receive a plurality of sentences, a plurality of speech style characteristics, a request to generate a synthetic speech, and the like, which may be inputted through an input device such as a touch screen, a keyboard, or the like. Accordingly, the received request and/or the result of processing the request may be provided to the information processing system 230 through the communication module 316 and the network 220.

The processor 314 may receive a plurality of sentences through the input device 320 and the input and output interface 318. The processor 314 may receive a plurality of sentences, which are inputted through the input device 320 (e.g., a keyboard), through the input and output interface 318. The processor 314 may receive an input to upload a document format file including a plurality of sentences through the user interface, through the input device 320 and the input and output interface 318. In response to this input, the processor 314 may receive a document format file corresponding to the input from the memory 312. In addition, in response to the input, the processor 314 may receive a plurality of sentences included in the document format file. The received plurality of sentences may be provided to the information processing system 230 through the communication module 316. Alternatively, the processor 314 may be configured to provide the uploaded file to the information processing system 230 through the communication module 316, and receive the plurality of sentences included in the file from the information processing system 230.

The processor 314 may receive a plurality of speech style characteristics for the plurality of sentences through the input device 320 and the input and output interface 318. The processor 314 may receive a response for selecting at least one speech style characteristic from among a plurality of speech style characteristic candidates for each of the plurality of sentences, which are output to the user terminal 210. The plurality of speech style characteristic candidates may include a recommended speech style characteristic candidate that is determined based on a result of analyzing the plurality of sentences through natural language processing (e.g., a sentence spoken by the same speaker, prosody of the sentence, emotion, context, or the like). The received plurality of speech style characteristics for the plurality of sentences may be provided to the information processing system 230 through the communication module 316.

The processor 314 may receive a response to at least one of a plurality of synthetic speeches through the input device 320 and the input and output interface 318. The processor 314 may receive a request to change at least one speech style characteristic corresponding to the at least one sentence. The processor 314 may receive a request to change at least one sentence associated with the at least one synthetic speech. The processor 314 may receive whether or not to use the at least one synthetic speech of the plurality of synthetic speeches. The received response to the at least one synthetic speech of the plurality of synthetic speeches may be provided to the information processing system 230 through the communication module 316.

The processor 314 may receive a plurality of synthetic speeches for a plurality of sentences through the communication module 316 from the information processing system 230. The plurality of synthetic speeches for the plurality of sentences may reflect the received plurality of speech style characteristics.

The processor 314 may be configured to output the processed information and/or data through the output device 320 of the user terminal 210, such as a device (e.g., a touch screen, a display, and the like) capable of outputting a display or a device (e.g., a speaker) capable of outputting an audio. The processor 314 may display the received plurality of sentences and markers corresponding to the plurality of speech style characteristics through the device capable of outputting a display or the like. For example, the processor 314 may output “My tall uncle” which is a sentence included in the received document format file, and “100” which is a marker corresponding to a speech style characteristic for the sentence, through a screen of the user terminal 210.

The processor 314 may output a synthetic speech for a plurality of sentences, or audio content including the synthetic speech through a device capable of outputting an audio. For example, the processor 314 may output the synthetic speech received from the information processing system 230, or audio content including the synthetic speech, through a speaker.

The processor 334 of the information processing system 230 may be configured to manage, process, and/or store the information and/or data received from a plurality of user terminals including the user terminal 210 and/or a plurality of external systems. The information and/or data processed by the processor 334 may be provided to the user terminal 210 through the communication module 336. For example, the processed information and/or data may be provided to the user terminal 210 in real time or may be provided later in the historical form.

The processor 334 may receive a plurality of sentences and/or a plurality of speech style characteristics from the user terminal 210, the memory 332 of the information processing system 230 or an external system (not shown), and generate synthetic speeches for the received plurality of sentences. The processor 334 may input the received plurality of sentences and the received plurality of speech style characteristics into an artificial neural network text-to-speech synthesis model, so as to generate the synthetic speeches for the plurality of sentences that reflect the plurality of speech style characteristics. The processor 334 may store the generated synthetic speeches in the memory 332, and may provide them to the user terminal 210 through the communication module 336.

The processor 334 may receive a response to at least one of a plurality of synthetic speeches from the user terminal 210. The processor 334 may receive a marker indicating whether or not to use the at least one synthetic speech in an area displaying at least one sentence associated with the at least one synthetic speech. A request to change at least one speech style characteristic corresponding to the at least one sentence and/or a request to change at least one sentence associated with the at least one synthetic speech may be received. In this case, the processor 334 may input the changed speech style characteristic and the changed at least one sentence into an artificial neural network text-to-speech synthesis model, so as to generate at least one synthetic speech for the changed at least one sentence that reflects the changed speech style characteristic.

A user terminal (or user account) from which the processor 334 receives a plurality of speech style characteristics for a plurality of sentences, and a user terminal (or user account) from which the processor 334 receives a response to at least one of a plurality of synthetic speeches may be different from each other. A plurality of speech style characteristics for a plurality of sentences may be received from a first user account (e.g., operator account) of a plurality of user accounts, and a response to at least one synthetic speech may be received from a second user account (e.g., inspector account) different from the first user account. A marker indicating whether or not to use the at least one synthetic speech in an area displaying at least one sentence associated with the at least one synthetic speech may be received from the second user account. If the received marker indicates not to use at least one synthetic speech, information on at least one sentence associated with the at least one synthetic speech may be provided to the first user account.

The processor 334 may analyze at least one of a plurality of sentences, a plurality of speech style characteristics, and/or a plurality of synthetic speeches to determine an inspection target. Based on a result of analyzing at least one of the plurality of speech style characteristics or the plurality of synthetic speeches, the processor 334 may select at least one sentence to be an inspection target from among the plurality of sentences, and output a visual representation indicating the inspection target in an area corresponding to the selected at least one sentence. For example, the processor 334 may analyze at least one synthetic speech that reflects one or more speech style characteristics through a speech recognizer such as a speech-to-text (STT) model so as to analyze the synthetic speech and/or the speech style characteristic reflected in the synthetic speech, and if the corresponding speech style characteristic is not clearly revealed, a sentence corresponding to one synthetic speech may be determined and output as an inspection target. As another example, if the synthetic speech does not correspond to the corresponding text, a sentence including the corresponding text may be determined and output as an inspection target.

If a user account (or user terminal) receiving a plurality of speech style characteristics is different from a user account (or user terminal) receiving a response to at least one of a plurality of synthetic speeches, a behavior pattern of the first user account that selects the plurality of speech style characteristics for the plurality of sentences may be analyzed to determine or select at least one sentence to be an inspection target from among the plurality of sentences. A visual representation indicating the inspection target may be output in an area corresponding to the at least one sentence that is determined or selected to be an inspection target through the second user account, and a request to change at least one speech style characteristic corresponding to the at least one sentence may be received from the second user account.

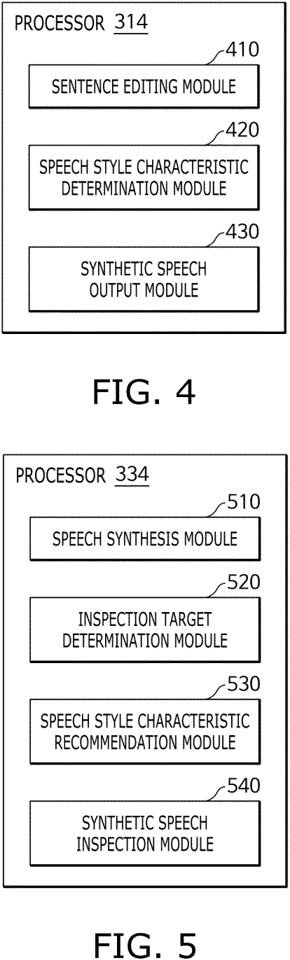

FIG. 4 is a block diagram showing an internal configuration of the processor 314 of the user terminal 210. As shown, the processor 314 may include a sentence editing module 410, a speech style characteristic determination module 420, and a synthetic speech output module 430. Each of the modules operated by the processor 314 may be configured to be connected to or in communication with each other.

The sentence editing module 410 may receive an input to edit at least a part of a plurality of sentences through the user interface operated in the user terminal 210 and/or the information processing system 230, and modify the part of the plurality of sentences in response to the received input. For example, spacing, pause, sentence division, typos, spellings, or the like for the part of the plurality of sentences may be modified. The modified part of the plurality of sentences as described above may be provided to the information processing system or displayed on a screen of the user terminal.

The speech style characteristic determination module 420 may determine or change the speech style characteristics for a plurality of sentences. The speech style characteristic determination module 420 may determine or change a plurality of speech style characteristics for a plurality of sentences, based on an input corresponding to the plurality of speech style characteristics for the plurality of sentences received through the user interface operated in the user terminal 210 and/or the information processing system 230. A marker corresponding to the determined or changed speech style characteristics may be displayed on a screen of the user terminal in an area associated with a sentence for the changed speech style characteristics. For example, the speech style characteristic determination module 420 may receive an input to select at least one of a plurality of sentences, receive an input to select at least one of a plurality of speech style characteristic candidates, and determine a speech style characteristic for the selected at least one sentence to be the at least one selected speech style characteristic candidate.

In the present disclosure, the speech style characteristic determination module 420 is shown as being included in the processor 314, but aspects are not limited thereto, and it may be configured to be included in the processor 334 of the information processing system 230. In addition, in FIG. 4, the one or more speech style characteristics determined through the speech style characteristic determination module 420 may be provided to the information processing system together with the plurality of corresponding sentences. The information processing system 230 may input the plurality of received sentences and the plurality of speech style characteristics for the plurality of sentences received as described above into an artificial neural network text-to-speech synthesis model, so as to generate a plurality of synthetic speeches for the plurality of sentences that reflect the plurality of speech style characteristics. The generated synthetic speeches may be output through the synthetic speech output module 430.

The synthetic speech output module 430 may receive an input indicating selection of at least one of a plurality of sentences, and may output only the synthetic speech corresponding to the selected at least one of the plurality of sentences through an output device of the user terminal. For example, in response to an input to select a part of the plurality of sentences received through an input device of the user terminal such as a keyboard or a mouse, a synthetic speech corresponding to the corresponding sentence may be output through a speaker of the user terminal.

A synthetic speech generation operator and/or inspector may listen to the synthetic speech output through the output device of the user terminal by the synthetic speech output module 430, and edit or change the plurality of sentences or the plurality of speech style characteristics for a part of the plurality of synthetic speeches. The sentence editing module 410 may receive a request to change or edit at least one sentence associated with at least one of the output plurality of synthetic speeches. The speech style characteristic determination module 420 may receive a request to change at least one speech style characteristic corresponding to the at least one sentence of the output synthetic speeches, and determine or change the plurality of speech style characteristics for the plurality of sentences.

FIG. 5 is a block diagram showing an internal configuration of the processor 334 of the information processing system 230. As shown, the processor 334 may include a speech synthesis module 510, an inspection target determination module 520, a speech style characteristic recommendation module 530, and a synthetic speech inspection module 540. Each of the modules operated by the processor 334 may be configured to communicate with each of the modules operated by the processor 314 of FIG. 4.

The speech synthesis module 510 may include an artificial neural network text-to-speech synthesis model. The speech synthesis module 510 may receive a plurality of sentences and a plurality of speech style characteristics for the plurality of sentences, and may be configured to input the received plurality of sentences and the received plurality of speech style characteristics into an artificial neural network text-to-speech synthesis model, so as to generate a plurality of synthetic speeches for the plurality of sentences that reflect the plurality of speech style characteristics. If a request to change a speech style characteristic and/or sentence is received, the speech synthesis module 510 may input the changed speech style characteristic and the changed at least one sentence into the artificial neural network text-to-speech synthesis model, so as to generate at least one synthetic speech for the changed at least one sentence that reflects the changed speech style characteristic. The generated synthetic speech may be provided to the user terminal and output to the user.

The inspection target determination module 520 may analyze a plurality of sentences, a plurality of speech style characteristics, and/or a synthetic speech, and output a sentence, a speech style characteristic, and/or a synthetic speech determined to be an inspection target. The inspection target determination module 520 may select or determine at least one sentence to be an inspection target from among the plurality of sentences based on a result of analyzing at least one of the plurality of speech style characteristics and/or the plurality of synthetic speeches. For example, if the sound quality of a synthetic speech is determined to be poor by a network that determines the sound quality of a synthetic speech, or if the synthetic speech is detected as being different from the sentence through speech recognition (e.g., speech recognition using an STT model, etc.), or if the emotion characteristic of the synthetic speech is different from that of adjacent sentences, the corresponding sentence may be selected or determined to be an inspection target.

A behavior pattern of a user account that has selected a plurality of speech style characteristics for a plurality of sentences may be analyzed to determine or select at least one sentence to be an inspection target from among the plurality of sentences. For example, if one speech style characteristic is mostly selected as the speech style characteristic for a plurality of sentences, and/or if the selected speech style characteristic is different from the speech style characteristic recommended by the speech style characteristic recommendation module 530, and/or if selection is performed too early without listening to a pre-listening speech that reflects at least one of speech style characteristic candidates, and/or if selection of the speech style characteristic for a particular sentence is too frequently changed, by using a machine learning system that is trained using data on a behavior pattern of a user account (e.g., operator account) that has selected the speech style characteristic, at least one sentence may be selected or determined to be an inspection target from among the plurality of sentences.

The speech style characteristic recommendation module 530 may analyze a plurality of sentences and determine a recommended speech style characteristic candidate for the plurality of sentences based on the analysis result. The speech style characteristic recommendation module 530 may analyze at least one of the plurality of sentences using the natural language processing or the like, and determine a recommended speech style characteristic candidate based on the analysis result. The recommended speech style characteristic candidate may be predetermined and stored. For example, the speech style characteristic recommendation module 530 may analyze or detect “Beom-su,” “energetically,” “answer,” and the like in “Beom-su answered energetically.” among a plurality of sentences, and determine the recommended speech style characteristic for the next sentence, “Yes, that’s right,” to be “energetically,” “loudly,” or “roaringly. In addition, the speech style characteristic recommendation module 530 may determine a recommended character to be “Beom-su” or a speaker including the utterance style characteristic, emotion characteristic, and prosody characteristic of “Beom-su,” which may be analyzed from a plurality of sentences. As another example, the speech style characteristic recommendation module 530 may analyze “I am so tired and had a hard time today” among the plurality of sentences, and determine the recommended speech style characteristic for the corresponding sentence to be “sullenly,” “nervelessly,” “in a low voice,” or the like. The recommended speech style characteristic candidate determined as described above may be included in the speech style characteristic candidates and displayed on a screen of the user terminal through the user interface.

The synthetic speech inspection module 540 may receive a confirmation or a pass/fail as an inspection result for the synthetic speech corresponding to a plurality of sentences from the user account (e.g., inspector account). The confirmation as to the synthetic speech may include whether or not to use the synthetic speech corresponding to the plurality of sentences. If the synthetic speech inspection module 540 determines that all the synthetic speeches for the plurality of sentences are confirmed, audio content including the synthetic speech may be generated. The synthetic speech inspection module 540 may receive, from the user terminal, the confirmation as to the plurality of sentences, the plurality of speech style characteristics, and/or the synthetic speech, which are the inspection targets output from the inspection target determination module 520. If the synthetic speech inspection module 540 determines that all the synthetic speeches for the plurality of sentences as the inspection targets have passed, audio content including the synthetic speeches may be generated. The generated audio content may be provided to the user terminal, and output through the output device of the user terminal.

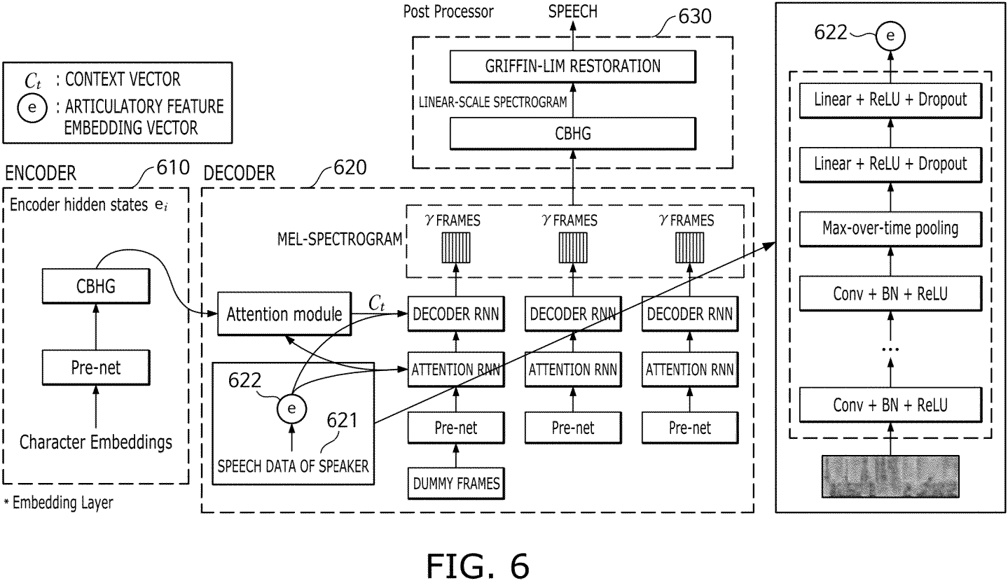

FIG. 6 is a diagram illustrating a configuration of an artificial neural network-based text-to-speech synthesis device, and a network for extracting an embedding vector 622 that can distinguish each of a plurality of speakers and/or speech style characteristics. The text-to-speech synthesis device may be configured to include an encoder 610, a decoder 620, and a post-processing processor 630. The text-to-speech synthesis device may be configured to be included in the system for generating synthetic speech.

The encoder 610 may receive a character embedding for one or more sentences, as shown in FIG. 6. The one or more sentences may include at least one of word, phrase, or sentence used in one or more languages. For example, the encoder 610 may receive one or more sentences through the user interface. If one or more sentences are received, the encoder 610 may separate the received sentences into consonant units, letter units, and phoneme units. The encoder 610 may receive the sentences divided into the syllable unit, the character unit, or the phoneme unit. the encoder 610 may convert one or more sentences into embeddings having a predetermined size, for example, consonant embeddings, character embeddings, and/or phoneme embeddings.

The encoder 610 may be configured to generate the text as pronunciation information. The encoder 610 may pass the generated character embeddings through a pre-net including a fully-connected layer. In addition, the encoder 610 may provide the output from the pre-net to a CBHG module to output encoder hidden states eᵢ as shown in FIG. 6. For example, the CBHG module may include a ID convolution bank, a max pooling, a highway network, and a bidirectional gated recurrent unit (GRU).

If the encoder 610 receives one or more sentences or the divided one or more sentences, the encoder 610 may be configured to generate at least one embedding layer. The at least one embedding layer of the encoder 610 may generate the character embeddings on the basis of the one or more sentences divided in the syllable unit, character unit, or phoneme unit. For example, the encoder 610 may use a machine learning model (e.g., a probability model, an artificial neural network, or the like) that has already been trained to acquire the character embedding on the basis of the divided one or more sentences. Furthermore, the encoder 610 may update the machine learning model while performing machine learning. If the machine learning model is updated, the character embeddings for the divided one or more sentences may also be changed. The encoder 610 may pass the character embeddings through a deep neural network (DNN) module composed of the fully-connected layers. The DNN may include a general feedforward layer or a linear layer. The encoder 610 may provide the output of the DNN to a module including at least one of a convolutional neural network (CNN) or a recurrent neural network (RNN), and generate hidden states of the encoder 610. While the CNN may capture local characteristics according to the size of the convolution kernel, the RNN may capture long term dependency. The hidden states of the encoder 610, that is, the pronunciation information for the one or more sentences may be provided to the decoder 620 including the attention module, and the decoder 620 may be configured to generate such pronunciation information into a speech.

The decoder 620 may receive the hidden states eᵢ of the encoder from the encoder 610. As shown in FIG. 6, the decoder 620 may include an attention module, the pre-net composed of the fully-connected layers, and a gated recurrent unit (GRU), and may include an attention recurrent neural network (RNN) and a decoder RNN including a residual GRU. In this example, the attention RNN may output information to be used in the attention module. In addition, the decoder RNN may receive position information of the one or more sentences from the attention module. That is, the position information may include information regarding which position in the one or more sentences is being converted into a speech by the decoder 620. The decoder RNN may receive information from the attention RNN. The information received from the attention RNN may include information regarding which speeches the decoder 620 has generated up to the previous time-step. The decoder RNN may generate the next output speech following the speeches that have been generated so far. For example, the output speech may have a mel spectrogram form, and the output speech may include r frames.

The pre-net included in the decoder 620 may be replaced with the DNN composed of the fully-connected layers. In this example, the DNN may include at least one of a general feedforward layer or a linear layer.

In addition, like the encoder 610, in order to generate or update the artificial neural network text-to-speech synthesis model, the decoder 620 may use a database existing as a pair of information related to the one or more sentences, speaker and/or speech style characteristics, and speech signal corresponding to the one or more sentences. The decoder 620 may be trained with the information related to the one or more sentences, speakers, and/or speech style characteristics as the inputs of to the artificial neural neural network, respectively, and the speech signals corresponding to the one or more sentences as the correct answer. The decoder 620 may apply the information related to the one or more sentences, speakers and/or speech style characteristics to the updated single artificial network neural network text-to-speech synthesis model, and output a speech corresponding to the speakers and/or speech style characteristics.

In addition, the output of the decoder 620 may be provided to the post-processing processor 630. The CBHG of the post-processing processor 630 may be configured to convert the mel-scale spectrogram of the decoder 620 into a linear-scale spectrogram. For example, the output signal of the CBHG of the post-processing processor 630 may include a magnitude spectrogram. The phase of the output signal of the CBHG of the post-processing processor 630 may be restored through the Griffin-Lim algorithm and subjected to the Inverse Short-Time Fourier Transform. The post-processing processor 630 may output a speech signal in a time domain.

Alternatively, the output of the decoder 620 may be provided to a vocoder (not shown). For the purpose of text-to-speech synthesis, the operations of the DNN, the attention RNN, and the decoder RNN may be repeatedly performed. For example, the r frames acquired in the initial time-step may become the inputs of the subsequent time-step. Also, the r frames output in the subsequent time-step may become the inputs of the subsequent time-step that follows. Through the process described above, speeches may be generated for all units of the text.

The text-to-speech synthesis device may acquire the speech of the mel-spectrogram for the whole text by concatenating the mel-spectrograms for the respective time-steps in chronological order. The vocoder may predict the phase of the spectrogram through the Griffin-Lim algorithm. The vocoder may output the speech signal in time domain using the Inverse Short-Time Fourier Transform.

The vocoder may generate the speech signal from the mel-spectrogram based on a machine learning model. The machine learning model may include a model trained about the correlation between the mel spectrogram and the speech signal. For example, the vocoder may be implemented by using the artificial neural network model such as WaveNet, WaveRNN, and WaveGlow, which has the mel spectrogram or linear prediction coefficient (LPC), line spectral pair (LSP), line spectral frequency (LSF), or pitch period as the inputs, and has the speech signals as the outputs.

The artificial neural network-based text-to-speech synthesis device may be trained using a large database existing as the text-speech signal pair. A loss function may be defined by comparing the output to the text that is entered as the input, with the corresponding target speech signal. The text-to-speech synthesis device may learn the loss function through the error back propagation algorithm to finally obtain a single artificial neural network text-to-speech synthesis model that outputs a desired speech if any text is input.

The decoder 620 may receive the hidden states eᵢ of the encoder from the encoder 610. The decoder 620 of FIG. 6 may receive speech data 621 corresponding to a specific speaker and/or a specific speech style characteristic. The speech data 621 may include data representing a speech input from a speaker within a predetermined time period (a short time period, e.g., several seconds, tens of seconds, or tens of minutes). For example, the speech data 621 of a speaker may include speech spectrogram data (e.g., log-mel-spectrogram). The decoder 620 may acquire the embedding vector 622 representing the speaker and/or speech style characteristics based on the speaker’s speech data. The decoder 620 of FIG. 6 may receive a single-hot speaker ID vector or speaker vector for each speaker, and based on this, may acquire the embedding vector 622 representing the speaker and/or speech style characteristic. The acquired embedding vector may be stored in advance, and if a specific speaker and/or speech style characteristic is requested through the user interface, a synthetic speech may be generated using the embedding vector corresponding to the requested information among the previously stored embedding vectors. The decoder 620 may provide the acquired embedding vector 622 to the attention RNN and the decoder RNN.

The text-to-speech synthesis device shown in FIG. 6 provides a plurality of previously stored embedding vectors corresponding to a plurality of speakers and/or a plurality of speech style characteristics. If the user selects a specific character or a specific speech style characteristic through the user interface, a synthetic speech may be generated using the embedding vector corresponding thereto. Alternatively, in order to generate a new speaker vector, the text-to-speech synthesis device may provide a TTS system that can immediately generate a speech of a new speaker, that is, that can adaptively generate the speech of the new speaker without further training the text-to-speech (TTS) model or manually searching for the speaker embedding vectors. That is, the text-to-speech synthesis device may generate speeches that are adaptively changed for a plurality of speakers. In FIG. 6, it may be configured such that, if synthesizing a speech for the one or more sentences, the embedding vector 622 extracted from the speech data 621 of a specific speaker may be input to the decoder RNN and the attention RNN. A synthetic speech may be generated, which reflects at least one characteristic from among a vocal characteristic, a prosody characteristic, an emotion characteristic, or a tone and pitch characteristic included in the embedding vector 622 of the specific speaker.

The network shown in FIG. 6 may include a convolutional network and max over time pooling, and may receive a log-Mel-spectrogram and extract a fixed-dimensional speaker embedding vector as a speech sample or a speech signal. In this example, the speech sample or the speech signal is not necessarily the speech data corresponding to the one or more sentences, and any selected speech signal may be used.

In such a network, any spectrogram may be inserted into this network because there are no restrictions on the use of the spectrograms. In addition, through this, the embedding vector 622 representing a new speaker and/or a new speech style characteristic may be generated through the immediate adaptation of the network. The input spectrogram may have various lengths, but for example, a fixed dimensional vector having a length of 1 with respect to the time axis may be input to the max-over-time pooling layer located at the end of the convolutional layer.

FIG. 6 shows a network including the convolutional network and the max over time pooling, but a network including various layers can be established to extract the speaker and/or speech style characteristics. For example, a network may be implemented to extract characteristics using the recurrent neural network (RNN), if there is a change in the speech characteristic pattern over time, such as an intonation, among the speaker and/or speech style characteristics.

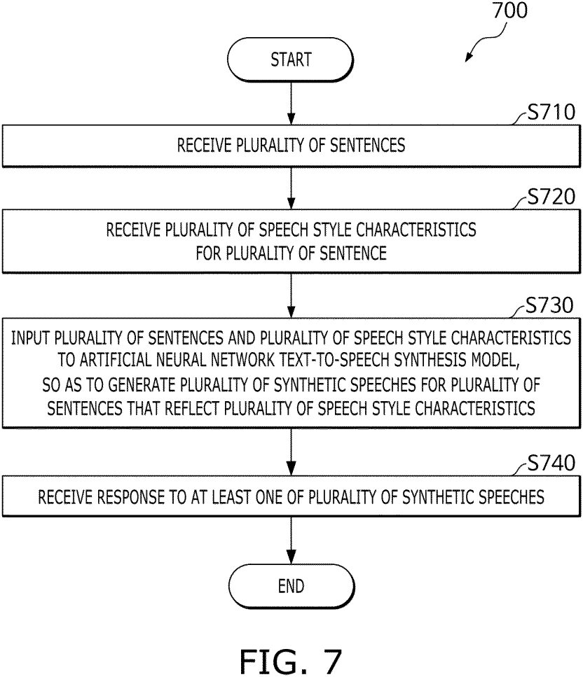

FIG. 7 is a flowchart illustrating a method 700 for performing the synthetic speech generation operation. The method 700 for performing the synthetic speech generation operation may be performed on a user terminal (e.g., the user terminal 210 of FIG. 3, and the like) and/or an information processing system (e.g., the information processing system 230 of FIG. 3, and the like). As shown, the method 700 for performing the synthetic speech generation operation may be initiated at S710 by receiving a plurality of sentences. Based on a request for a plurality of sentences received through a user interface operated in the user terminal, the information processing system may receive a plurality of sentences. For example, based on a request for a text input received through the user interface or a request for a document file including a plurality of sentences, the processor of the information processing system may receive a plurality of sentences from the user terminal, an external system, or a memory of the information processing system.

At S720, the processor may receive a plurality of speech style characteristics for the plurality of sentences. The processor may receive an input for at least one of a plurality of speech style characteristic candidates for the plurality of sentences. For example, the processor may receive a number inputted to an area corresponding to at least one of the plurality of sentences through the user interface, and receive a speech style characteristic corresponding to the received number. As another example, the processor may receive an input of clicking one of the numbers output to an area corresponding to at least one of the plurality of sentences through the user interface, and receive a speech style characteristic corresponding to the clicked number.

At S730, the processor may input the plurality of sentences and the plurality of speech style characteristics into an artificial neural network text-to-speech synthesis model, so as to generate a plurality of synthetic speeches for the plurality of sentences that reflect the plurality of speech style characteristics. For the plurality of sentences, the processor may generate a synthetic speech that reflects at least one characteristic from among a vocal characteristic, a prosody characteristic, an emotion characteristic, or a tone and pitch characteristic included in the plurality of speech style characteristics.

At S740, a response to at least one of a plurality of synthetic speeches may be received. The processor may receive a request to change at least one speech style characteristic corresponding to at least one sentence. The processor may receive whether or not the at least one of the plurality of synthetic speeches has passed. For example, a marker indicating whether or not to use the at least one synthetic speech in an area displaying at least one sentence associated with the at least one synthetic speech, may be received.

At S710, S720, and S740, respectively, a user account providing the plurality of sentences to the information processing system, a user account providing the plurality of speech style characteristics for the plurality of sentences, and a user account providing the response to the at least one of the plurality of synthetic speeches may be all different, partially different, or all the same.

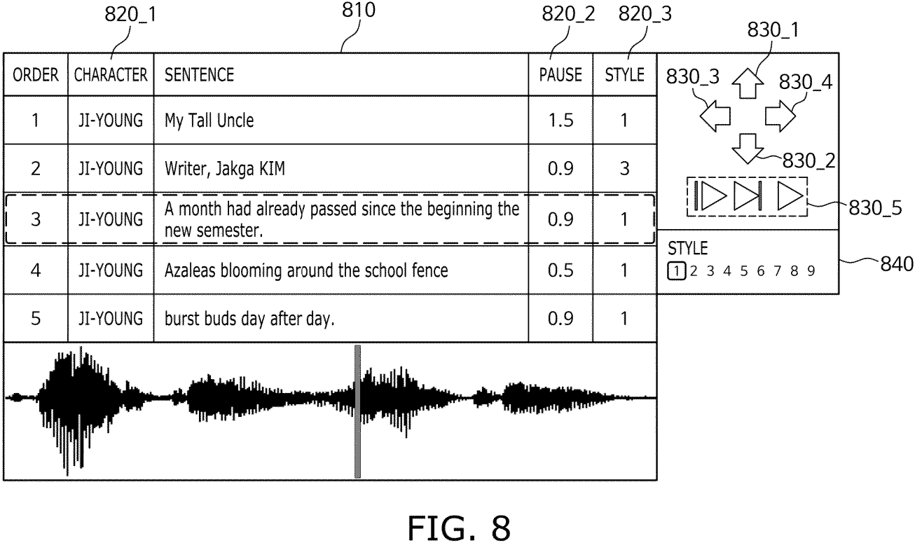

FIG. 8 is a diagram illustrating an operation in a user interface for an operator generating a synthetic speech. The user interface shown in FIG. 1 is an example of the user interface for the operator generating the synthetic speech, and the user interface shown in FIG. 8 may be another example of the user interface for the operator generating the synthetic speech. The processor may receive a plurality of sentences, and the received plurality of sentences may be output through the user interface. As shown in FIG. 8, each of a plurality of sentences 810 received by the processor including “My tall uncle,” “Writer, Jakga KIM,” “A month had already passed since the beginning of the new semester,” “Azaleas blooming around the school fence,” and “burst buds day after day.” may be displayed in a table form, in a respective row, through the user interface. The user interface shown in FIG. 8 may operate in the terminal of the synthetic speech generation operator account (or first user account).

The processor may receive a plurality of speech style characteristics 820 for the plurality of sentences. The speech style characteristics 820 may include, as shown, a character (or speaker) uttering a sentence 820_1, a pause between the corresponding sentence and the next sentence in a synthetic speech 820_2, an utterance style characteristic 820_3, and the like. Additionally, the speech style characteristics 820 may include a characteristic for utterance speed. The plurality of speech style characteristics for the plurality of sentences received as described above may be provided to the operator account or the inspector account, and may be displayed through the user interface.

The processor may receive an input indicating selection of at least one of the plurality of sentences, and receive an input for a speech style characteristic of the selected sentence. In addition, an indicator indicating selection may be output together in an area corresponding to the selected plurality of sentences through the user interface. For example, as shown, a thick border may be displayed in a row corresponding to the third sentence selected from among the plurality of sentences (“A month had already passed since the beginning of the new semester.”).

Selection of at least one of the plurality of sentences may be performed through an input device of the user terminal. Selection of at least one of the plurality of sentences may be performed by clicking through a mouse or a touch pad. For example, selection of at least one of the plurality of sentences may be performed by clicking an area corresponding to the at least one of the plurality of sentences. As another example, it may be performed by clicking up and down arrow icons 830_1 and 830_2 output in the user interface. Selection of at least one of the plurality of sentences may be performed by an input through arrow keys of a keyboard of the user terminal.

For example, an indicator (e.g., thick border) indicating selection of at least one of the plurality of sentences may be moved up and down in a table listing the plurality of sentences, based on an input through the up and down arrow keys of the keyboard of the user terminal, or an input by clicking the up and down arrow icons 830_1 and 830_2. If the indicator indicating selection according to such movements is located in at least one of the plurality of sentences, the processor may receive an input indicating selection of the corresponding sentence.

The processor may receive an input of text or a number corresponding to a character, pause, and/or utterance style characteristic for the selected at least one of the plurality of sentences, and may receive a speech style characteristic according to the received input. As shown, for the third sentence, “Ji-young” may be input in the character column, “0.9” in the pause column, and “1” in the utterance style characteristic column, and accordingly, the processor may receive, for the third sentence, the speech style characteristics corresponding to “Ji-young,” “0.9,” and “1” as the character, pause, and utterance style characteristic, respectively.

The processor may output a plurality of speech style characteristic candidates 840 for each of the plurality of sentences, and may receive an input indicating selection of at least one of the output speech style characteristic candidates 840. Meanwhile, the plurality of speech style characteristic candidates 840 may include a recommended speech style characteristic candidate that is determined based on a result of analyzing the plurality of sentences. For example, selection of a speech style characteristic may be performed by clicking a mouse or a touch pad on at least one of the speech style characteristic candidates. As another example, selection of at least one of the speech style characteristic candidates may be performed by clicking left and right arrow icons 830_3 and 830_4 output in the user interface. As still another example, selection of at least one of the speech style characteristic candidates may be performed by an input through arrow keys of a keyboard of the user terminal.

As shown in FIG. 8, numbers from “1” to “9” corresponding to each of the plurality of speech style characteristic candidates 840 for the selected sentence may be output through the user interface, and “1” corresponding to “vigorously” may be selected from among “1” to “9” corresponding to each of the plurality of speech style characteristic candidates 840, respectively. Accordingly, in response to receiving an input indicating selection of “1,” the processor may receive “vigorously” corresponding to “1” as a speech style characteristic for the third sentence. Alternatively, the plurality of speech style characteristic candidates 840 may include speech style characteristics for utterance speed, and numbers from “1” to “9” may correspond to speech style characteristics for utterance speed. For example, “1” may correspond to the slowest utterance speed, and “9” may correspond to the fastest utterance speed.

The processor may input the plurality of sentences and the plurality of speech style characteristics into an artificial neural network text-to-speech synthesis model, so as to generate a plurality of synthetic speeches for the plurality of sentences that reflect the plurality of speech style characteristics. The processor may input a sentence selected through the user interface and the speech style characteristic for the corresponding sentence into the artificial neural network text-to-speech synthesis model to generate a synthetic speech for the selected sentence that reflects the speech style characteristic, and output it through the user terminal (e.g., terminal of operator or inspector).

According to a click (or touch) input on an icon 830_5 associated with a playback of a synthetic speech displayed on the user interface or an input through a keyboard of the user terminal, the generated synthetic speech may be output through an output device of the user terminal. For example, if a “space bar” input is received from the keyboard of the user terminal, the processor may output or stop outputting the synthetic speech for the current sentence. As another example, if a “shift+space bar” input of the keyboard is received, the processor may continue outputting synthetic speeches for sentences from the current sentence. As still another example, if a “shift+enter” input of the keyboard is received, the processor may continue outputting synthetic speeches for sentences from the first sentence.

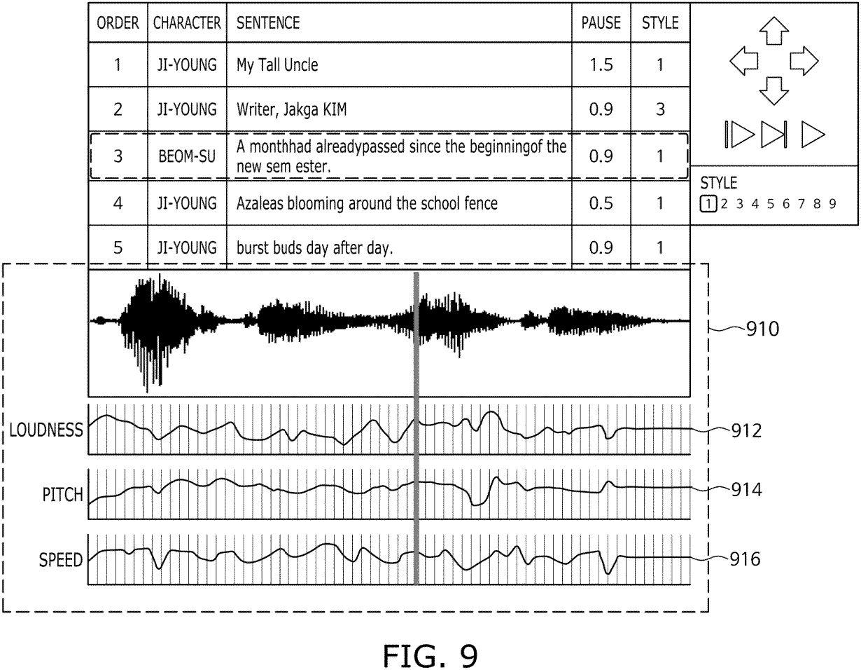

FIG. 9 is a diagram illustrating an operation in the user interface of the operator generating a synthetic speech. The user interface shown in FIG. 9 may operate in the terminal of the synthetic speech generation operator account (or first user account).

In response to at least one of a plurality of synthetic speeches, the processor may receive a request to modify or change at least one sentence associated with the at least one synthetic speech, a speech style characteristic, and/or a synthetic speech. For example, spacing, pause, sentence division, typos, spellings, or the like for at least a part of the plurality of sentences may be modified. The processor may receive a request to change a sentence through the input device of the user terminal, and accordingly, the sentence “A monthhad alreadypassed since the beginningof the new sem ester” may be modified or changed to “A month had already passed since the beginning of the new semester.” In addition, the processor may receive a request to change the speech style characteristics through the input device of the user terminal, and accordingly, the character (or speaker) of the third sentence may be modified or changed from “Beom-su” to “Ji-young.” As another example, the processor may receive a request from the operator account to cut or edit the waveform of the synthetic speech, and modify or change the synthetic speech.

The plurality of speech style characteristics received by the processor may include local style characteristics. The local style characteristics may include speech style characteristics for at least a part of one or more sentences. In this case, the “part” as used herein may include not only the sentence, but also the phonemes, letters, words, syllables, and the like divided into units smaller than sentences.

A user interface operated in a terminal of the synthetic speech generation operator account may include an interface 910 for changing a speech style characteristic for at least a part of selected sentence. For example, if the operator selects a third sentence 920, the interface 910 for changing a value representing the speech style characteristic may be output. As shown in the interface 910, a loudness setting graph 912, a pitch setting graph 914, and a speed setting graph 916 are shown, but aspects are not limited thereto, and any information representing speech style characteristics may be displayed. In each of the loudness setting graph 912, the pitch setting graph 914, and the speed setting graph 916, the x-axis may represent the size of the unit (e.g., phoneme, letter, word, syllable, sentence, etc.) by which the user can change the speech style, and the y-axis may represent a style value of each unit.

In this embodiment, the speech style characteristic may include a sequential prosody characteristic including prosody information corresponding to at least one unit of a frame, a phoneme, a letter, a syllable, a word, or a sentence in chronological order. In an example, the prosody information may include at least one of information on the volume of the sound, information on the pitch of the sound, information on the length of the sound, information on the pause duration of the sound, or information on the speed of the sound. In addition, the style of the sound may include any form, manner, or nuance that the sound or speech expresses, and may include, for example, tone, intonation, emotion, etc. inherent in the sound or speech. Further, the sequential prosody characteristic may be represented by a plurality of embedding vectors, and each of the plurality of embedding vectors may correspond to the prosody information included in chronological order. The user may modify the y-axis value at a feature point of the x-axis in at least one graph shown in the interface 910. For example, in order to emphasize a specific phoneme or character in a given sentence, the user may increase the y-axis value at the x-axis point corresponding to the corresponding phoneme or letter in the loudness setting graph 912. In response, the information processing system may receive the changed y-axis value corresponding to the phoneme or letter, and input the speech style characteristic including the changed y-axis value and one or more sentences including the phoneme or letter corresponding thereto to the artificial neural network text-to-speech synthesis model, and generate a synthetic speech based on the speech data output from the artificial neural network text-to-speech synthesis model. The synthetic speech generated as described above may be provided to the user through the user interface. To this end, among a plurality of embedding vectors corresponding to the speech style characteristic, the information processing system may change the values of one or more embedding vectors corresponding to the corresponding x-axis point with reference to the changed y-axis value.

In order to change the speech style characteristic of at least a part of the given sentence, the user may provide the speech of the user reading the given sentence in a manner desired by the user to the information processing system through the user interface. The information processing system may input the received speech into an artificial neural network configured to infer the input speech as the sequential prosody characteristic, and output the sequential prosody characteristics corresponding to the received speech. The output sequential prosody characteristics may be expressed by one or more embedding vectors. These one or more embedding vectors may be reflected in the graph provided through the interface 910.

FIG. 9 shows the loudness setting graph 912, the pitch setting graph 914, and the speed setting graph 916 included in the interface 910 for changing local style, but embodiment is not limited thereto, and a graph of the mel scale spectogram corresponding to the speech data for a synthetic speech may also be shown.

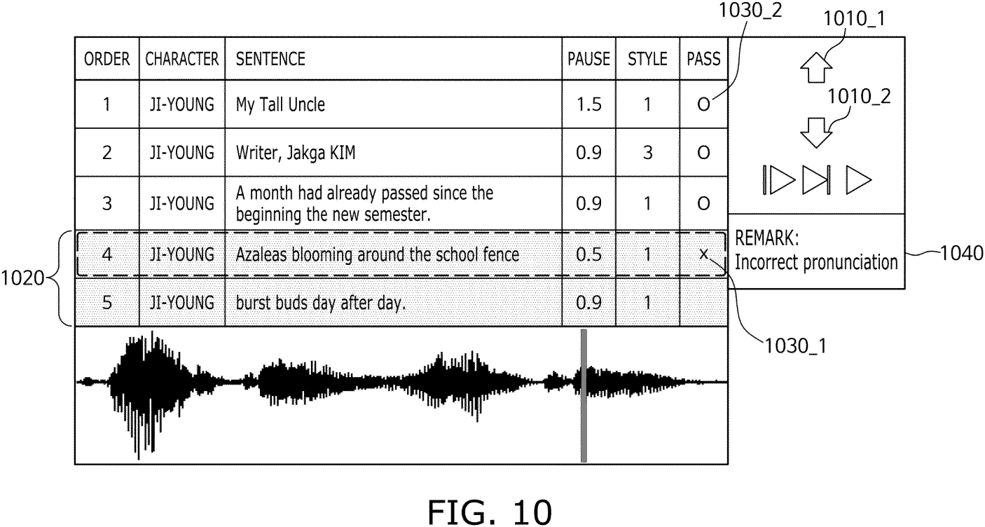

FIG. 10 is a diagram illustrating an operation in the user interface of the inspector inspecting the generated synthetic speech. The user interface shown in FIG. 10 may operate in the terminal of the synthetic speech generation inspector account (or second user account).

The processor may provide a plurality of sentences, a plurality of speech style characteristics, and a generated synthetic speech for the plurality of sentences received as described above, to the inspector account. The plurality of sentences, the plurality of speech style characteristics, and the synthetic speech provided as described above may be output through an output device of a user terminal of the inspector account. For example, the plurality of sentences and the plurality of speech style characteristics provided by the processor may be displayed on a screen of the user terminal through the user interface of the inspector. As another example, the synthetic speech provided by the processor may be output through a speaker of the user terminal of the inspector. The inspector may select at least one of the plurality of sentences through an input device of the user terminal, and a synthetic speech for the selected sentence may be output through an output device of the user terminal.

Selection of at least one of the plurality of sentences may be performed by clicking through a mouse or a touch pad. For example, selection of at least one of the plurality of sentences may be performed by clicking an area corresponding to the at least one of the plurality of sentences. As another example, it may be performed by clicking up and down arrow icons 1010_1 and 1010_2 output in the user interface. Selection of at least one of the plurality of sentences may be performed by an input through arrow keys of a keyboard of the user terminal.

For example, an indicator (e.g., thick border) indicating selection of at least one of the plurality of sentences may be moved up and down in a table listing the plurality of sentences, based on an input through the up and down arrow keys of the keyboard of the user terminal, or an input by clicking the up and down arrow icons 1010_1 and 1010_2. If the indicator indicating selection according to such movements is located in at least one of the plurality of sentences, the processor may receive an input indicating selection of the corresponding sentence, and may provide a synthetic speech for the sentence to the inspector account and output it through the output device of the user terminal.

Based on a result of analyzing at least one of the plurality of speech style characteristics or the plurality of synthetic speeches, the processor may select at least one sentence to be an inspection target from among the plurality of sentences, and output a visual representation 1020 indicating the inspection target in an area corresponding to the selected at least one sentence. For example, if the sound quality of synthetic speech is determined to be poor by a network that determines the sound quality of a synthetic speech, or if the synthetic speech is detected as different from the sentence through speech recognition, or if the emotion characteristic of the synthetic speech is different from that of adj acent sentences, the corresponding sentence may be selected or determined to be an inspection target.

The processor may analyze a behavior pattern of the user account (e.g., first user account or operator account) that has selected a plurality of speech style characteristics for a plurality of sentences, select at least one sentence to be an inspection target from among the plurality of sentences, and output the visual representation 1020 indicating the inspection target in an area corresponding to the selected at least one sentence. For example, if one speech style characteristic is mostly selected as the speech style characteristic for a plurality of sentences, or if the selected speech style characteristic is different from the speech style characteristic recommended by the processor, or if selection is performed too early without listening to a pre-listening speech that reflects at least one of speech style characteristic candidates, or if selection of the speech style characteristic for a particular sentence is too frequently changed, by using a machine learning system that is trained using data on a behavior pattern of a user account (e.g., operator account) that has selected the speech style characteristic, at least one sentence may be selected or determined to be an inspection target from among the plurality of sentences. For the visual representation 1020 indicating the inspection target in an area corresponding the sentence selected or determined to be an inspection target, its output color or shade may be different from that of other areas.

As shown in FIG. 10, the processor may analyze at least one of a plurality of speech style characteristics and/or a plurality of synthetic speeches, or analyze a behavior pattern of a user account that has selected the speech style characteristic to determine the fourth and fifth sentences to be inspection targets, and may output a shade in an area corresponding to the fourth and fifth sentences.

The user (or inspector) may listen to each of a plurality of synthetic speeches for a plurality of sentences output through the user terminal, determine whether or not to use the output synthetic speeches, and input markers 1030_1 or 1030_2 corresponding to the determination in an area associated with each sentence. On the other hand, the user may listen to only the synthetic speeches for the sentences which are determined or judged to be inspection targets by the processor, determine whether or not to use the synthetic speeches, and input the markers 1030_1 or 1030_2 corresponding to the determination in a related area. For example, the user may input the marker 1030_1 (e.g., a marker “X”) indicating that the synthetic speech for at least one of the plurality of sentences has failed, or is not to be used, in the related area through a “space bar” input of a keyboard, which is an input device of the user terminal.

Accordingly, the processor may receive the markers 1030_1 and 1030_2 indicating whether or not to use the at least one synthetic speech in an area displaying at least one sentence associated with the at least one synthetic speech. For example, the processor may receive the markers 1030_1 and 1030_2 indicating whether or not to use the at least one synthetic speech in an area displaying at least one sentence associated with the at least one synthetic speech through a user interface of the second user account (or inspector account).

As shown, the user may input a marker “O” indicating the pass (or confirmation) for the synthetic speeches for the first, second, and third sentences in the “pass” column of the first, second, and third sentences, and input a marker “X” 1030_1 indicating the fail of the synthetic speech for the fourth sentence in the “pass” column of the fourth sentence. The processor may receive the marker “O” 1030_2 or the marker “X” 1030_1 inputted as described above, and may provide the received marker to another user account (e.g., operator account).

The user (or inspector) may listen to each of the synthetic speeches for the plurality of sentences output through the user terminal, and if the output synthetic speech is determined to be a fail (or not to be used), the user may input the reason for the determination in a related area 1040 of the user interface. As shown, “The pronunciation is incorrect,” which is the reason for the fail of the synthetic speech for the fourth sentence, may be input in the related area (e.g., “Remark” column) 1040 of the user interface. The processor may receive the reason for the fail inputted through the user interface of the inspector account as a response to at least one of the plurality of synthetic speeches, and may provide the received response to the synthetic speech to another user account (e.g., operator account).

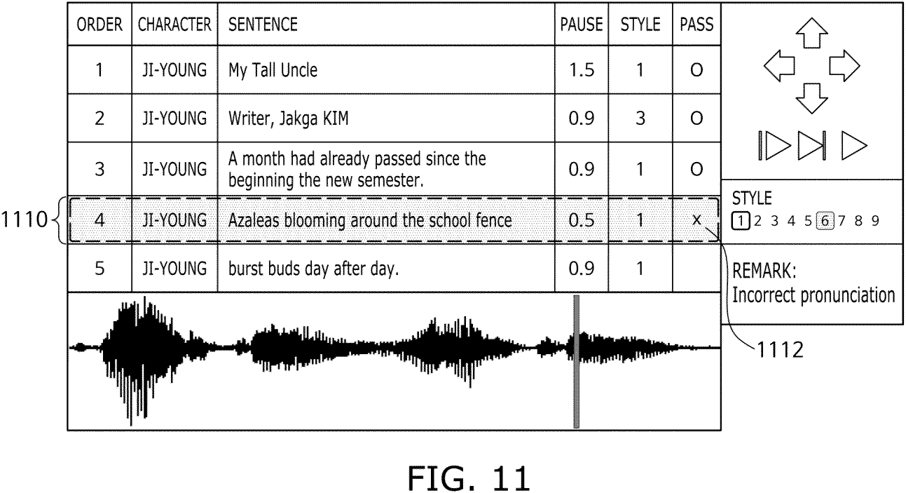

FIG. 11 is a diagram illustrating an operation in the user interface of the operator generating a synthetic speech. The user interface shown in FIG. 11 may operate in the terminal of the synthetic speech generation operator account (or first user account).

The processor may provide information on at least one sentence associated with a synthetic speech to the user account. The processor may receive a marker indicating whether or not to use at least one synthetic speech from the inspector account (or second user account). If the received marker indicates that the at least one synthetic speech is not to be used, the processor may provide information 1110 on at least one sentence associated with the at least one synthetic speech to the operator account (or first user account). For example, the information 1110 on the sentence for which the synthetic speech was determined not to be used (or fail) by the inspector may be output as a visual marker through the user interface of the operator. In addition, the processor may provide the reason for the fail received from the inspector account to the operator account, and output the same through the user interface of the operator account.

As shown, the processor may output, through the user interface of the operator, the marker “X” 1112 indicating that the synthetic speech is not to be used, in the “pass” column of the fourth sentence for which the synthetic speech was determined to be a fail by the inspector, and may output, in an area associated with the fourth sentence, a different color or shade from that of the other areas.

Based on the synthetic speech and the information provided by the processor, the operator account may change or maintain the sentence associated with the marker (e.g., marker “X”) 1112 indicating that the synthetic speech is not to be used, or may change or maintain the speech style characteristic associated with the same. As shown, the operator account can change the speech style characteristic for the fourth sentence from the speech style characteristic corresponding to “1” to the speech style characteristic corresponding to “6.” The processor may input the changed sentence and/or speech style characteristic into an artificial neural network text-to-speech synthesis model, and generate or output a changed synthetic speech.

The synthetic speech generation operation on text described above may be provided as a computer program stored in a computer-readable recording medium for execution on a computer. The medium may be a type of medium that continuously stores a program executable by a computer, or temporarily stores the program for execution or download. In addition, the medium may be a variety of recording means or storage means having a single piece of hardware or a combination of several pieces of hardware, and is not limited to a medium that is directly connected to any computer system, and accordingly, may be present on a network in a distributed manner. An example of the medium includes a medium configured to store program instructions, including a magnetic medium such as a hard disk, a floppy disk, and a magnetic tape, an optical medium such as a CD-ROM and a DVD, a magnetic-optical medium such as a floptical disk, and a ROM, a RAM, a flash memory, and so on. In addition, other examples of the medium may include an app store that distributes applications, a site that supplies or distributes various software, and a recording medium or a storage medium managed by a server.

The methods, operations, or techniques of the present disclosure may be implemented by various means. For example, these techniques may be implemented in hardware, firmware, software, or a combination thereof. Those skilled in the art will further appreciate that various illustrative logical blocks, modules, circuits, and algorithm steps described in connection with the disclosure herein may be implemented in electronic hardware, computer software, or combinations of both. To clearly illustrate this interchangeability of hardware and software, various illustrative components, blocks, modules, circuits, and steps have been described above generally in terms of their functionality. Whether such a function is implemented as hardware or software varies depending on design requirements imposed on the particular application and the overall system. Those skilled in the art may implement the described functions in varying ways for each particular application, but such implementation should not be interpreted as causing a departure from the scope of the present disclosure.

In a hardware implementation, processing units used to perform the techniques may be implemented in one or more ASICs, DSPs, digital signal processing devices (DSPDs), programmable logic devices (PLDs), field programmable gate arrays (FPGAs), processors, controllers, microcontrollers, microprocessors, electronic devices, other electronic units designed to perform the functions described in the present disclosure, computer, or a combination thereof.

Accordingly, various example logic blocks, modules, and circuits described in connection with the present disclosure may be implemented or performed with general purpose processors, DSPs, ASICs, FPGAs or other programmable logic devices, discrete gate or transistor logic, discrete hardware components, or any combination of those designed to perform the functions described herein. The general purpose processor may be a microprocessor, but in the alternative, the processor may be any related processor, controller, microcontroller, or state machine. The processor may also be implemented as a combination of computing devices, for example, a DSP and microprocessor, a plurality of microprocessors, one or more microprocessors associated with a DSP core, or any other combination of the configurations.

In the implementation using firmware and/or software, the techniques may be implemented with instructions stored on a computer-readable medium, such as random access memory (RAM), read-only memory (ROM), non-volatile random access memory (NVRAM), programmable read-only memory (PROM), erasable programmable read-only memory (EPROM), electrically erasable PROM (EEPROM), flash memory, compact disc (CD), magnetic or optical data storage devices, and the like. The instructions may be executable by one or more processors, and may cause the processor(s) to perform certain aspects of the functions described in the present disclosure.

Although the examples described above have been described as utilizing aspects of the currently disclosed subject matter in one or more standalone computer systems, aspects are not limited thereto, and may be implemented in conjunction with any computing environment, such as a network or distributed computing environment. Furthermore, the aspects of the subject matter in the present disclosure may be implemented in multiple processing chips or devices, and storage may be similarly influenced across a plurality of devices. Such devices may include PCs, network servers, and portable devices.

Although the present disclosure has been described in connection with some examples herein, various modifications and changes can be made without departing from the scope of the present disclosure, which can be understood by those skilled in the art to which the present disclosure pertains. In addition, such modifications and changes should be considered within the scope of the claims appended herein.

What is claimed is:

1. A method for performing a synthetic speech generation operation on text, comprising:
receiving a plurality of sentences;
receiving a plurality of speech style characteristics for the plurality of sentences;
inputting the plurality of sentences and the plurality of speech style characteristics into an artificial neural network text-to-speech synthesis model, so as to generate a plurality of synthetic speeches for the plurality of sentences that reflect the plurality of speech style characteristics; and
receiving a response to at least one of the plurality of synthetic speeches.

2. The method according to claim 1, wherein the receiving the response to the at least one of the plurality of synthetic speeches includes:
selecting at least one sentence to be an inspection target from among the plurality of sentences based on a result of analyzing at least one of the plurality of speech style characteristics or the plurality of synthetic speeches;
outputting a visual representation indicating the inspection target in an area corresponding to the selected at least one sentence; and
receiving a request to change at least one speech style characteristic corresponding to the at least one sentence.

3. The method according to claim 2, wherein the receiving the response to the at least one of the plurality of synthetic speeches further includes receiving a request to change at least one sentence associated with the at least one synthetic speech, and
the method further includes inputting the changed at least one speech style characteristic and the changed at least one sentence into the artificial neural network text-to-speech synthesis model, so as to generate at least one synthetic speech for the changed at least one sentence that reflects the changed at least one speech style characteristic.

4. The method according to claim 1, wherein the receiving the plurality of speech style characteristics for the plurality of sentences includes receiving, from a first user account, a plurality of speech style characteristics for the plurality of sentences,
the receiving the response to the at least one of the plurality of synthetic speeches includes receiving, from a second user account, a response to the at least one synthetic speech, and
the first user account is different from the second user account.

5. The method according to claim 4, wherein the receiving, from the second user account, the response to the at least one synthetic speech includes:
selecting at least one sentence to be an inspection target from among the plurality of sentences by analyzing a behavior pattern of the first user account that selects the plurality of speech style characteristics for the plurality of sentences;
outputting a visual representation indicating the inspection target in an area corresponding to the selected at least one sentence; and
receiving, from the second user account, a request to change at least one speech style characteristic corresponding to the at least one sentence.

6. The method according to claim 4, wherein the receiving, from the second user account, the response to the at least one synthetic speech further includes receiving a marker indicating whether or not to use the at least one synthetic speech, in an area displaying at least one sentence associated with the at least one synthetic speech.

7. The method according to claim 6, further comprising, if the marker indicates that the at least one synthetic speech is not to be used, providing information on the at least one sentence associated with the at least one synthetic speech to the first user account.

8. The method according to claim 1, wherein the receiving the plurality of speech style characteristics for the plurality of sentences includes:
outputting a plurality of speech style characteristic candidates for each of the plurality of sentences; and
receiving a response for selecting at least one speech style characteristic from among the plurality of speech style characteristic candidates.

9. The method according to claim 8, wherein the plurality of speech style characteristic candidates includes a recommended speech style characteristic candidate that is determined based on a result of analyzing the plurality of sentences.

10. A non-transitory computer-readable recording medium storing instructions that, when executed by one or more processors, cause performance of the method according to claim 1.
